(19) United States
(12) Patent Application Publication
(10) Pub. No.: US 2022/0381445 A1
(43) Pub. Date: Dec. 1, 2022

(54) SMOKELESS AIR-FRY DRIP PAN

(71) Applicant: Electrolux Home Products, Inc., Charlotte, NC (US)

(72) Inventors: Tim Brown, Joelton, TN (US); Steven Swayne, Springfield, TN (US); Timothy Turner, Springfield, TN (US)

(21) Appl. No.: 17/332,238

(22) Filed: May 27, 2021

(51) Int. Cl. F24C 15/14; A23L 5/10; F24C 15/16

(52) U.S. Cl. CPC F24C 15/14; A23L 5/15; A23L 5/17; F24C 15/16; A23V 2002/00

(57) ABSTRACT

A drip pan assembly includes an drip pan and a duct body attached to a lower surface of the drip pan. An upper surface of the drip pan at least partially defines a containment area where food drippings are collected/deposited. A bounded air channel extends along a lower surface of the drip pan for directing a flow of convective air along the lower surface.

### FIELD OF THE INVENTION

The present invention relates to a drip pan assembly for a convection oven, and more particularly, to a drip pan assembly including a drip pan and an air channel extending along a lower surface of the drip pan.

### BACKGROUND OF THE INVENTION

Convection ovens typically include an insulated cavity defining a cooking space and a fan disposed at a rear wall of the cavity. In these ovens, the fan circulates air inside the cavity for normalizing the temperature of the cooking space. During certain convection-based cooking operations, e.g. air-frying, in which foods being cooked are held in wire baskets or trays to expose the underside of the food to heated air, drippings in the form of fats, lards, oils, etc. are released from the food items and fall through openings in the basket or tray onto a bottom wall of the cavity. Such drippings can be caused to exceed their smoke point and/or flash upon impacting the heated bottom wall, e.g. if a lower bake element is active. Accordingly, the drippings can start to burn and emit smoke, which is undesirable.

To prevent the drippings from falling on the bottom wall, some users place a drip pan beneath the cooking rack or basket to catch the drippings. However, heat from the bottom wall or the lower bake element may cause the temperature of the drip pan to reach the smoke point temperature, thereby causing the drippings to burn and emit smoke upon contact with the drip pan.

It is desirable to have a drip pan that is capable of maintaining a surface temperature less than a smoke point temperature of drippings released from food items being cooked in the tray/basket above during cooking, to minimize the amount of smoke released into the cooking space.

### SUMMARY OF THE INVENTION

There is provided a drip pan assembly for an oven. The drip pan assembly has a drip pan including a lower surface and an upper surface at least partially defining a containment area, and a bounded air channel extending along the lower surface of the drip pan and configured to confine a flow of convective air along the lower surface.

There is also provided an air-frying rack assembly for an oven. The air-frying rack assembly has a rack including a receptacle opening and a basket disposed in the receptacle opening. The basket is configured to accommodate food items therein. A drip pan assembly is positioned below the basket. The drip pan assembly includes an drip pan including an upper surface that at least partially defines a containment area and a lower surface. A duct body is attached to the lower surface of the drip pan. The duct body includes an expansive portion spaced from the lower surface of the drip pan and at least partially defining therewith a bounded air channel extending along the lower surface of the drip pan and configured to confine a flow of convective air along the lower surface.

There is also provided a method for frying food via air as the frying medium in an oven cavity of a kitchen appliance. The method includes receiving food to be air-fried within the oven cavity supported by a rack assembly disposed therein. The rack assembly includes a body having a receptacle opening. A basket is disposed in the receptacle opening, and a drip pan assembly is positioned below the basket. The food is held in the basket such that drippings therefrom during air-frying pass through openings in the basket and fall to the drip pan assembly below. The method further includes receiving a user selection to activate an air-fry mode including a pre-heat phase and a subsequent post-heat phase; receiving a desired air-frying temperature setpoint; heating the oven cavity during the pre-heat phase such that a measured temperature of the oven cavity exceeds the air-frying temperature setpoint and reaches a first overshoot temperature; and thereafter heating the oven cavity during the post-heat phase such that the measured temperature of the oven cavity reaches a second overshoot temperature that is greater than the air-frying temperature setpoint. During the post-heat phase the measured temperature of the oven cavity is maintained substantially constant or within a predetermined range encompassing the second overshoot temperature. In the method, the first overshoot temperature is different than the second overshoot temperature.

### BRIEF DESCRIPTION OF THE DRAWINGS

FIG. 1 is a front, perspective view of a cooking appliance having a convection oven cavity with a basket supported by a rack suspended within the cavity, and a drip pan assembly according to a first embodiment suspended from the rack;

FIG. 2 is an exploded perspective view of the basket, the drip pan assembly and rack of FIG. 1;

FIG. 3 is an exploded, perspective view of the drip pan assembly of FIG. 1;

FIG. 4 is a bottom perspective view of a drip pan assembly according to a second embodiment;

FIG. 5A is a bottom perspective view of the drip pan assembly of FIG. 1; and

FIG. 5B is a bottom perspective view of the drip pan assembly of FIG. 1 according to a third embodiment.

### DETAILED DESCRIPTION OF PREFERRED EMBODIMENTS

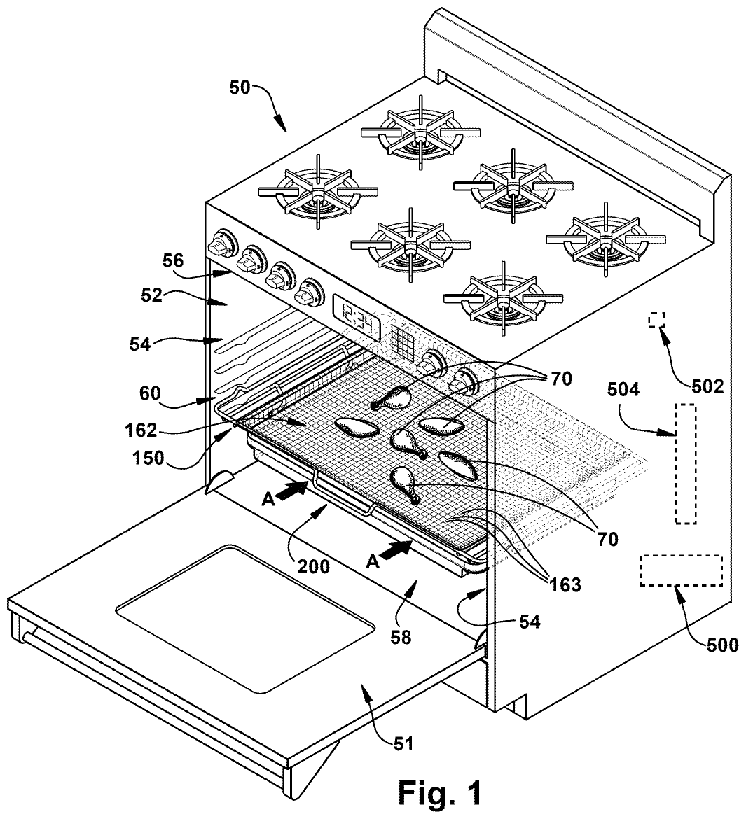

Referring now to the drawings, FIG. 1 shows a front perspective view of a major cooking appliance 50 having an oven with an interior or oven cavity 52, with a door 51 of the oven in an open position. A freestanding range is illustrated in FIG. 1. But the major cooking appliance also could be a built-in oven or wall-oven as known in the art. Although the detailed description that follows concerns a convection oven (i.e. one fitted with a convection system to circulate heated air therein), the drip pan assembly described herein may be incorporated into other types of ovens, for example, but not limited to, portable cooktop ovens, ovens not equipped with convection systems, and the like. In the illustrated embodiment, the cavity 52 is defined by opposing side walls 54, a rear wall (not shown), a bottom wall 58, and a top wall 56. A plurality of vertically spaced guides or rails 60 are formed in the opposing side walls 54 for supporting a rack, e.g., the rack 150 as herein described. A convection fan 504 typically is provided at the rear wall (not shown) of the cavity 52 in the case of a convection oven. In the illustrated embodiment, a basket 162 is supported by the rack 150 and a drip pan assembly 200 is suspended from the rack 150.

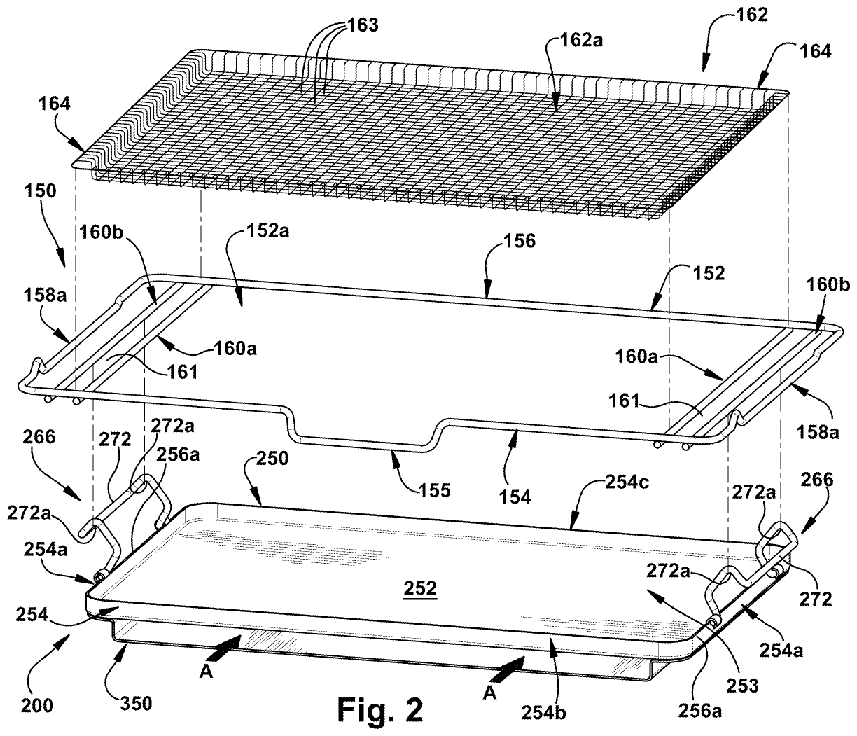

Referring to FIG. 2, the rack 150 includes a generally rectangular-shaped wire frame 152 made of a rigid, corrosion resistant material suitable for use in a convection oven, for example, but not limited to stainless steel, aluminum, etc. The wire frame 152 includes a front rail 154, a rear rail 156, and opposing side rails 158a. A handle 155 may be formed in the front rail 154 for allowing a user to insert/remove the rack 150 into/from the cavity 52 (FIG. 1). A plurality of support bars 160a, 160b extend between the front rail 154 and the rear rail 156. In the embodiment shown, there are four support bars 160a, 160b. It is contemplated that the support bars 160a, 160b may be different in number and location. In the illustrated embodiment the support bars 160a, 160b are positioned near the side rails 158a to define a receptacle opening 152a of the rack 150. In the embodiment shown, the receptacle opening 152a located centrally within the rack 150 and is defined by the front rail 154, the rear rail 156 and the innermost pair of support bars 160a. The receptacle opening 152a is shaped and dimensioned to receive the basket 162, as explained in detail below. In the embodiment shown, an opening 161 is defined between each pair of support bars 160a, 160b.

The basket 162 may be a generally planar structure having a plurality of drainage openings 163 formed in a lower wall 162a of the basket 162. It is contemplated that an entirety or at least a portion of the lower wall 162a of the basket 162 may be formed of a mesh-like material, such as a wire mesh composed of an array of laterally- and depth-wise-extending wires forming a crisscross grid pattern defining a corresponding array of openings 163 between the wires forming the mesh. Alternatively, the lower wall 162a can be a solid planar wall with openings 163 formed (e.g. cut or drilled) therein. It is contemplated that the basket 162 may take on different shapes and forms, for example, but not limited to, a concave or U-shaped basket. As seen in FIG. 2, preferably the basket 162 includes a perimeter flange 164 extending laterally about at least a portion of the perimeter of the basket 162. Upon insertion of the basket 162 through the opening 161 in the receptacle opening 152a of the rack 150, the perimeter flange 164 overhangs one or more of the rails and bars of the rack 150 defining the receptacle opening 152a, thereby suspending the basket 162 from and within the rack 150.

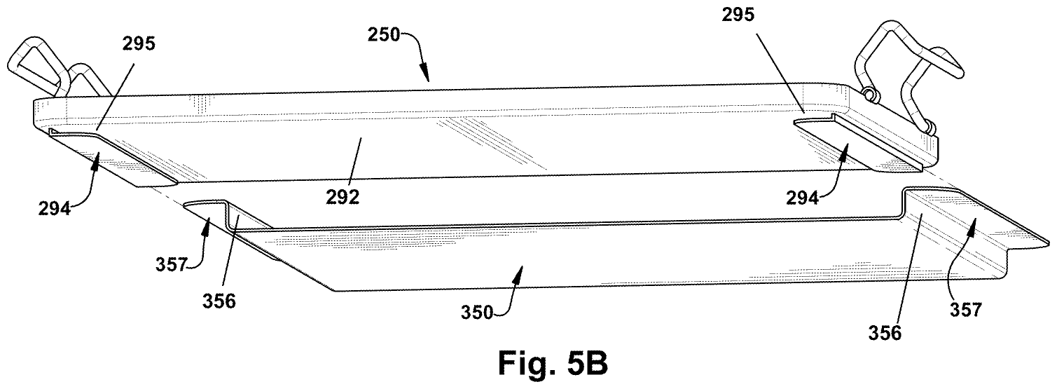

The drip pan assembly 200 according to a first embodiment, generally includes a drip pan 250 and a duct body 350. The drip pan 250 may be formed of a rigid, corrosion resistant material suitable for use in a convection oven, for example, but not limited to, stainless steel, aluminum, etc. The drip pan 250 includes an upper surface 252 and a lower surface 292 (FIG. 5A). In the illustrated embodiment, the drip pan 250 is in the form of a substantially rectangular tray having a perimeter wall 254 and a solid lower wall defining the upper surface 252, which is a flat, planar surface. It is contemplated that the upper surface 252 may embody other shapes, for example, but not limited to, a depressed, rounded, or concaved upper surface, etc. In general, the upper surface 252 serves as a containment area 253 where food drippings are deposited/collected, as described in detail below. It is bounded by the upwardly extending perimeter wall 254, such that together therewith the containment area 253 defines a reservoir to accumulate drippings from the basket above. In another embodiment (not shown), the drip pan 250 may not have the upwardly extending perimeter wall 254 and the containment area 253 may be defined by a contoured recess formed in the upper surface 252 or an entirety of the upper surface 252 may be spherical-shaped or bowl-shaped. It is also contemplated that a trough (not shown) may be formed in the upper surface 252 to provide a location where drippings are concentrated, in which case the contour of the surrounding upper surface 252 may be such that drippings will be caused to flow toward and into the trough to accumulate and be concentrated therein.

In the embodiment shown, the upwardly extending perimeter wall 254 is a contiguous, vertical wall including spaced-apart opposing side walls 254a that are connected by a front wall 254b and a rear wall 254c. It is contemplated that the upwardly extending perimeter wall 254 may embody other shapes and forms, for example, but not limited to a slanted or curved wall.

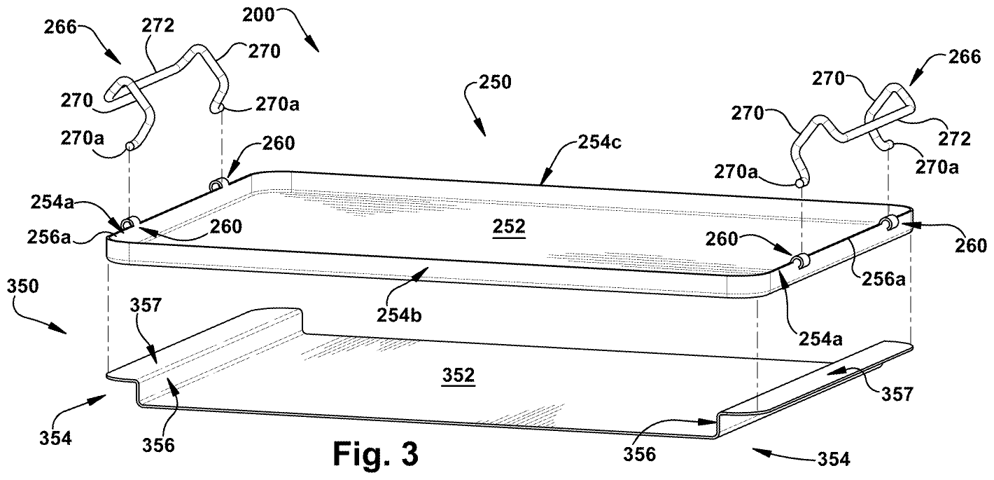

Referring to FIG. 3, a hanger 266 may be attached to each side wall 254a of the drip pan 250. In the embodiment shown, each hanger 266 includes a pair of arms 270 spaced apart and connected by a downwardly extending overhang portion 272. In some examples, it is contemplated that each hanger 266 may be formed of shaped memory wire. Each arm 270 may include a bent end 270a that is positioned as explained in detail below. It is contemplated that each hanger 266 may take on other forms, for example, but not limited to a single hook, a resilient clip, etc. In the illustrated embodiment, each hanger 266 is attached to an upper edge 256a of a respective side wall 254a. It is contemplated that each hanger 266 may be disposed in an alternative location, for example, but not limited to, an outside surface of each side wall 254a. It is also contemplated that each hanger 266 may be provided on other opposing walls such as the front wall 254b and the rear wall 254c.

Each side wall 254a may include one or more (e.g. a pair as shown) retainers 260 disposed thereon for securing each hanger 266 thereto, as explained in detail below. In the illustrated embodiment, each retainer 260 embodies a sleeve that is disposed on the upper edge 256a of each side wall 254a. It is contemplated that the retainers 260 may be different in number and may take on other shapes and forms, for example, but not limited to, clips, slots, hooks, keys, snaps, hinges, holes, etc. Each retainer 260 is dimensioned and positioned, as explained in detail below.

The duct body 350 is attached to the lower surface 292 (FIG. 5A) of the drip pan 250 and includes a lower, central, expansive portion 352 that is recessed relative to opposing ends 354 of the duct body 350. The duct body 350 may be made of a rigid, corrosion resistant material suitable for use in a convection oven, for example, but not limited to, stainless steel, aluminum, etc. It is contemplated that the duct body 350 may be formed by bending a flat piece of sheet metal to have upturned, opposing ends 354.

As shown in the illustrated embodiment, each opposing end 354 of the duct body 350 may be formed to define an upwardly extending leg 356. An outwardly extending flange 357 may extend from a distal end of each leg 356. It is contemplated that each leg 356 may take on other shapes and forms and may optionally be formed without the flange 357.

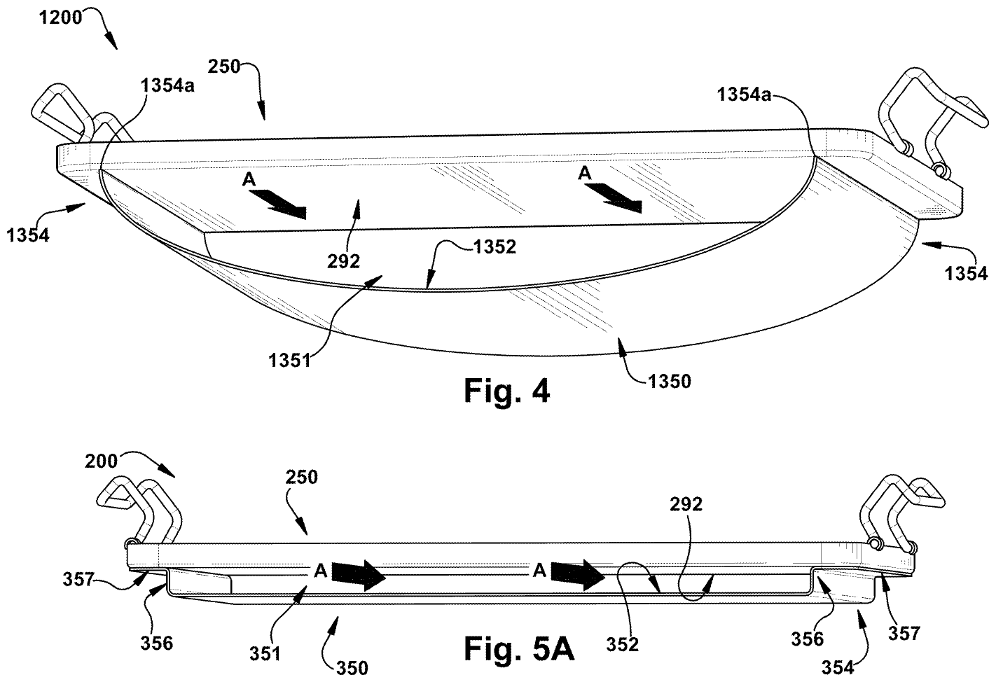

Referring to FIG. 4, a drip pan assembly 1200 according to a second embodiment is shown. The drip pan assembly 1200 of the second embodiment includes the drip pan 250 of the first embodiment with a duct body 1350 according to a second embodiment. The drip pan assembly 1200 is essentially the same as the first embodiment, except that the central, expansive portion 1352 thereof is a generally arcuate-shaped such that it curves generally away from the lower surface 292 of the drip pan 250 toward its center, instead of being planar.

The drip pan assembly 200 of the first embodiment will now be further described in relation to a use condition thereof. Referring to FIG. 5A, the duct body 350 is attached to the lower surface 292 of the drip pan 250. Each flange 357 may be spot welded to the lower surface 292 of the drip pan 250 for securing the duct body 350 to the drip pan 250. Alternatively, the flanges 357 can be attached to the drip pan 250 via fasteners such as rivets, bolts, or the like. Further still, for example if it is desired that the duct body 350 and drip pan 250 can be separated for cleaning, then the flanges 357 may be reversibly received and secured by tabs 294 extending from the lower surface 292 of the drip pan 250, which define slots 295 for receiving and retaining the edge of the associated flange 357; e.g. via a tab-and-slot mechanism of assembly as shown in FIG. 5B. If flanges 357 are omitted, it is contemplated that the distal end of each leg 356 may be directly secured (e.g. via welding) to the lower surface 292 of the drip pan 250.

Referring back to FIG. 3, the retainers 260 located on each side wall 254a of the drip pan 250 may be used to secure the hangers 266 to the drip pan 250. In the embodiment shown, the arms 270 of each hanger 266 may be pinched inwardly until the bent ends 270a have enough clearance to be inserted through the retainers 260. Each retainer 260 may have an internal contour that is shaped and dimensioned to accommodate each bent end 270a such that each bent end 270a may freely rotate in the respective retainer 260. The retainer 260 may be a sleeve having an inner diameter dimensioned to receive the bent end 270a of the respective hanger 266. In another embodiment, the bent ends 270a may be inserted through the retainers 260 and the retainers 260 may be crimped tightly around the respective bent end 270a to secure each hanger 266 to the drip pan 250 in a fixed orientation. Each hanger 266 may be formed without the bent ends 270a such that the arms 270 of each hanger 266 are attached to the side walls 254 via some form of bonding (e.g. welding) and/or secured within openings or holes in the side walls 254.

Referring back to FIG. 4, assembly of the drip pan assembly 1200 according to the second embodiment is similar to the first embodiment.

For each of the foregoing embodiments of the drip pan assembly 200, 1200, when the duct body 350, 1350 is secured to the drip pan 250, the expansive portion 352, 1352 of the duct body 350, 1350 is spaced below the lower surface 292 of the drip pan 250 to define a bounded air channel 351, 1351 therebetween, as described in detail below.

The drip pan assembly 200, 1200 may be positioned below the rack 150 and lifted upwards (e.g., by grasping each hanger 266) such that the overhang portion 272 of each hanger 266 passes through the opening 161 defined between a respective pair of support bars 160a, 160b in the rack 150. The bent ends 270a of each hanger 266 may freely rotate about the retainers 260 for enabling the hangers 266 to pivot when navigating the overhang portions 272 through the openings 161. When the overhang portions 272 clear the openings 161, they may be positioned above the support bars 160b and lowered thereon such that an apex 272a of each hanger 266 rests against the respective support bar 160b, thereby suspending the drip pan assembly 200, 1200 below the rack 150. With the basket 162 received in the receptacle opening of the rack 150, this results in the drip pan assembly being suspended beneath the basket 162.

In another embodiment, the drip pan assembly 200, 1200 may be made dimensionally smaller than the receptacle opening 152a of the rack 150 such that the entire drip pan assembly 200 may fit through (e.g., in a state wherein the basket 162 is removed) the receptacle opening 152a. In this embodiment, the drip pan assembly 200, 1200 may be positioned above the rack 150 and lowered through the receptacle opening 152a such that the apex 272a of each hanger 266 rests against the respective support bar 160a. thereafter, the basket 162 would be inserted in the receptacle opening 152a.

For an air-frying process, a controller 500 of the appliance 50 may receive a user selection to activate an air-fry mode, e.g. based on inputs executed on a user interface thereof. The controller 500 is schematically illustrated at FIG. 1 and is provided for controlling operation of heating elements (not shown) for heating the oven cavity 52 to cook food, and of a convection fan 504 for circulating heated air within that cavity 52. As will be understood, the controller 500 of the cooking appliance 50 can be configured to operate any one of the heating elements and the convection fan 504 independently of one another, or in conjunction with any one or more of the other of the heating elements and the convection fan 504. To provide this control, the controller 500 is communicatively connected to each of the heating elements, to the convection fan 504, and to at least one sensor 502 (FIG. 1—shown schematically) adapted to monitor the temperature of the oven cavity 52. The controller 500 includes at least a processor (not shown) and a storage (not shown), such as a memory, which in embodiments may be integral with the processor.

The controller 500 may be configured to operate one or more heating elements and the convection fan 504 of the appliance to execute an air-fry cooking mode, for example having a pre-heat phase and a subsequent post-heat phase. To facilitate air-fry mode, the controller 500 receives a desired air-frying temperature setpoint from the user. Based on the inputted temperature setpoint, the controller 500 energizes the one or more heating elements and the convection fan 504 to heat the oven cavity 52 during the pre-heat phase such that a measured temperature of the oven cavity 52 exceeds the air-frying temperature setpoint and reaches a first overshoot temperature.

The air fry algorithm is configured to cause a user prompt to be issued prior to the cavity 52 reaching the first overshoot temperature, which can occur during or at the conclusion of the pre-heat phase. The prompt may be at least one of visual, audible or tactile, and is intended to notify the user that the food item(s) to be cooked via air-frying should be inserted into the oven cavity 52.

After the prompt is issue, and presumably after the food has been inserted to the cavity 52 (e.g. as might be known from the controller 500 recognizing that the door 51 has been cycled), the controller 500 then controls the appliance in the post-heat phase such that the measured temperature of the oven cavity 52 reaches a second overshoot temperature that is greater than the air-frying temperature setpoint, but preferably not as high as the first overshoot temperature. The controller 500 may be configured such that during the post-heat phase the at least a subset of the heating elements and the convection fan 504 are operated according to a post-heat duty cycle in order to maintain the measured temperature of the oven cavity 52 substantially constant or within a predetermined range encompassing the second overshoot temperature. As noted above, it is contemplated that the first overshoot temperature may be different than the second overshoot temperature.

As the food items 70 cook in the basket 162 during an air-fry cooking mode, they may release drippings, which will pass through the plurality of drainage openings 163 formed in the basket 162 and fall onto the containment area 253 (FIG. 2) of the drip pan 250 of the drip pan assembly 200, 1200 suspended beneath the basket 152. Separately, the convection fan 504 that is used to circulate heated air throughout the cavity 52 also will induce an air flow through the air channel 351, 1351 of the drip pan assembly, e.g. along flow path A (FIGS. 4 and 5A). As the temperature in the cavity 52 approaches the cooking temperature, the heated air circulating through the air channel 351, 1351 will be uniformly maintained at the cooking temperature, and will never approach the elevated temperatures likely to be prevalent, e.g., at the bottom wall of the oven, which may be located adjacent to a heating element.

The circulating air, which is at the operative cooking temperature, continuously passes through the air channel 351, confined therein by the opposing duct body 350. The resulting confined channel 351 results in a relatively continuous, high-rate flow of air passing by and in contact with the lower surface 292 of the drip pan 250, thereby effectively exchanging heat therewith. In this manner, the flowing stream of air through channel 351 acts as an insulating layer between the duct body 350, 1350 and the drip pan 250, e.g. providing a heat shield between heating elements below the duct body 350, 1350 and the drip pan 250. Moreover, the air stream through the channel 351 further acts as a heat sink, exchanging and absorbing heat with the drip pan 250 that accumulates drippings from the basket above, which ensures that the drip pan 250 is maintained and substantially equilibrated at the air temperature within the cavity. Equilibration at the cooking temperature ensures that the drip pan 250 will not reach a smoke point for drippings accumulated on the upper surface thereof.

In this manner, air flowing through the air channel 351 ensures that drippings in the containment area 253 will not reach their smoke point. Stated another way, the duct body 350, 1350 and the air channel 351 help limit the temperature of the drip pan 250 so that the drippings collected in the containment area 253 do not exceed temperatures that may cause the drippings to burn and smoke.

Illustrative embodiments have been described, hereinabove. It should be appreciated that features of the embodiments described herein may be combined. Therefore, this disclosure is not limited to the specific details and representations shown and described. For example, it should be appreciated that the drip pan assemblies described herein may be adapted to mount to other forms of cookware. It will be apparent to those skilled in the art that the above apparatuses and methods may incorporate changes and modifications without departing from the scope of this disclosure. The invention is therefore not limited to particular details of the disclosed embodiments, but rather encompasses the spirit and the scope thereof as embodied in the appended claims.

What is claimed is:

1. A drip pan assembly for an oven, the drip pan assembly comprising:
a drip pan comprising a lower surface and an upper surface at least partially defining a containment area; and
a bounded air channel extending along the lower surface of the first body and configured to confine a flow of convective air along the lower surface.

2. The drip pan assembly according to claim 1, further comprising a duct body attached to the lower surface of the drip pan, the duct body comprising an expansive portion spaced from the lower surface of the drip pan, wherein the lower surface of the drip pan and the expansive portion of the duct body at least partially define the bounded air channel.

3. The drip pan assembly according to claim 2, wherein the expansive portion of the duct body is a central portion thereof, the duct body further comprising opposing leg portions extending upward from opposing ends of the central, expansive portion.

4. The drip pan assembly according to claim 3, further comprising opposing flanges extending from upper ends of the respective leg portions, said opposing flanges being attached to the lower surface of the drip pan to secure the duct body to the drip pan.

5. The drip pan assembly according to claim 1, wherein a hanger is attached to the drip pan for suspending the drip pan assembly below a rack.

6. The drip pan assembly according to claim 1, the drip pan comprising a perimeter wall about the upper surface, said perimeter wall and the upper surface of the drip pan defining the containment area.

7. The drip pan assembly according to claim 6, said perimeter wall including opposing side walls each including a retainer for securing a hanger to the respective side wall.

8. The drip pan assembly according to claim 7, wherein each said hanger comprises a pair of arms spaced apart and connected by an overhang portion.

9. The drip pan assembly according to claim 8, wherein each of said pair of arms includes an end dimensioned to be received by a respective said retainer.

10. The drip pan assembly according to claim 1, further comprising a hanger attached to the drip pan and suspending the drip pan assembly from a rack disposed in an oven cavity of a cooking appliance adapted to execute an air-fry mode such that the bounded air channel is aligned with a flow path for convective heated air in the oven cavity during said air-fry mode,
wherein the air-fry mode includes:
heating the oven cavity during a pre-heat phase such that a measured temperature of the oven cavity exceeds an air-frying temperature setpoint and reaches a first overshoot temperature; and
thereafter heating the oven cavity during a post-heat phase such that the measured temperature of the oven cavity reaches a second overshoot temperature that is greater than the air-frying temperature setpoint.

11. An air-frying rack assembly for an oven, comprising:
a rack including a receptacle opening;
a basket disposed in the receptacle opening, said basket being configured to accommodate food items therein; and
a drip pan assembly positioned below the basket, the drip pan assembly comprising:
a drip pan including an upper surface at least partially defining a containment area and a lower surface; and
a duct body attached to the lower surface of the drip pan, the duct body comprising an expansive portion spaced from the lower surface of the drip pan and at least partially defining therewith a bounded air channel extending along the lower surface of the drip pan and configured to confine a flow of convective air along the lower surface.

12. The air-frying rack assembly according to claim 11, the drip pan further comprising opposing leg portions extending upward from opposing ends of the expansive portion thereof.

13. The air-frying rack assembly according to claim 12, the drip pan further comprising opposing flanges extending from upper ends of the respective leg portions, said flanges being attached to the lower surface of the drip pan.

14. The air-frying rack assembly according to claim 11, the rack comprising a wire frame comprising a front rail, a rear rail, a pair of opposing side rails, and a plurality of support bars extending between the front rail and the rear rail.

15. The air-frying rack assembly according to claim 14, wherein a handle is formed in the front rail for allowing a user to insert or remove the wire frame and the basket into or from the oven.

16. The air-frying rack assembly according to claim 11, wherein in use the drip pan is substantially equilibrated to an air temperature of the convective air via heat exchange therewith as the convective air passes through the bounded air channel.

17. The air-frying rack assembly according to claim 11, said basket comprising a plurality of drainage openings formed in a lower wall of the basket.

18. The air-frying rack assembly according to claim 11, the drip pan comprising perimeter wall formed about a periphery of the upper surface, said perimeter wall and the upper surface of the drip pan defining the containment area.

19. The air-frying rack assembly according to claim 11, wherein a hanger is attached to the drip pan for suspending the drip pan assembly below the rack.

20. The air-frying rack assembly according to claim 11, wherein the drip pan assembly is suspended from the rack via a pair of hangers and each hanger is attached to an opposing side of the drip pan.

21. The air-frying rack assembly according to claim 11, wherein the duct body comprises opposing edges attached to the lower surface of the drip pan for securing the duct body to the drip pan.

22. A method for frying food via air as a frying medium in an oven cavity of a kitchen appliance, the method comprising:
receiving food to be air-fried within the oven cavity supported by a rack assembly disposed therein, said rack assembly comprising a body having a receptacle opening, a basket disposed in the receptacle opening, and a drip pan assembly positioned below the basket, said food being held in said basket such that drippings therefrom during air-frying pass through openings in the basket and fall to the drip pan assembly below;
receiving a user selection to activate an air-fry mode including a pre-heat phase and a subsequent post-heat phase;
receiving a desired air-frying temperature setpoint;
heating the oven cavity during the pre-heat phase such that a measured temperature of the oven cavity exceeds the air-frying temperature setpoint and reaches a first overshoot temperature; and
thereafter heating the oven cavity during the post-heat phase such that the measured temperature of the oven cavity reaches a second overshoot temperature that is greater than the air-frying temperature setpoint, wherein during said post-heat phase the measured temperature of the oven cavity is maintained substantially constant or within a predetermined range encompassing said second overshoot temperature, and wherein the first overshoot temperature is different than the second overshoot temperature.

23. The method according to claim 22, wherein the drip pan assembly has an upper surface at least partially defining a containment area for said drippings, and a lower surface, a duct body being attached to the lower surface of the drip pan assembly, the duct body comprising an expansive portion spaced from the lower surface of the drip pan assembly and at least partially defining therewith a bounded air channel extending along the lower surface of the drip pan assembly.

24. The method according to claim 23, further comprising:
conveying heated air in the oven cavity through the bounded air channel extending along the lower surface of the drip pan via operation of a convection fan during said air-fry mode.

25. The method according to claim 22, further comprising providing a prompt to the user to insert the food into the oven cavity prior to the oven cavity reaching said first overshoot temperature.
